(19) United States
(12) Patent Application Publication
(10) Pub. No.: US 2026/0252164 A1
(43) Pub. Date: Aug. 27, 2026

(54) SYSTEM AND METHOD FOR FACILITATING SERVICE PROVISIONING AND USER-SERVICE PROVIDER INTERACTIONS USING AN INSIGHTS ENGINE FRAMEWORK

(71) Applicant: CenturyLink Intellectual Property LLC, Denver, CO (US)

(72) Inventors: Santhosh PLAKKATT, Bengaluru (IN); Ranga Babu MODADUGU, Bengaluru (IN)

(73) Assignee: CenturyLink Intellectual Property LLC, Denver, CO (US)

(21) Appl. No.: 19/419,722

(22) Filed: Dec. 15, 2025

Related U.S. Application Data
(60) Provisional application No. 63/763,685, filed on Feb. 26, 2025.

(51) Int. Cl. G06F 3/01; H04M 3/493

(52) U.S. Cl. CPC G06F 3/011; H04M 3/493

(57) ABSTRACT

Novel tools and techniques are provided for facilitating user–service provider interactions using an insights engine framework. In examples, a computing system may predict an intent(s) of a user, by analyzing queries or user interaction data of the user, in some cases, using an artificial intelligence ("AI") model. The computing system may access historical and current records of issues with services provisioned to a plurality of users within a geographic area in which a first service is provided to the user. The computing system may identify current or potential issues with the first service, based on the predicted intent(s) and the historical and current records of the issues. The computing system may autonomously perform actions (e.g., implementing updates or upgrades to equipment providing the first service, and/or ordering new equipment and dispatching technicians to install the new equipment, etc.) to address current or potential issues with the first service.

### CROSS-REFERENCE TO RELATED APPLICATIONS

This application claims the benefit of U.S. Provisional Application No. 63/763,685 filed February 26, 2025, entitled "System and Method for Facilitating Service Provisioning and User-Service Provider Interactions Using an Insights Engine Framework," which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for facilitating service provisioning and user–service provider interactions using an insights engine framework.

### BACKGROUND

When users interact with service providers via interactive voice response ("IVR") systems and/or chat response systems to connect with human service provider agents, existing systems are only capable of routing to available agents, with no consideration for capability of the agents to address potentially difficult users. Such systems also lack the capability to autonomously determine the intent, the sentiment, or the behavioral patterns of users when connecting with the human service provider agents. Such systems further lack the capability to autonomously identify issues with services provided to the users and to autonomously initiate actions to address such issues. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for facilitating service provisioning and user–service provider interactions using an insights engine framework, in accordance with various embodiments.

FIG. 2 depicts an example sequence flow for facilitating service provisioning and user–service provider interactions using an insights engine framework, in accordance with various embodiments.

FIGS. 3A and 3B depict flow diagrams illustrating an example method for facilitating service provisioning and user–service provider interactions using an insights engine framework, in accordance with various embodiments.

FIG. 4 depicts a flow diagram illustrating an example method for facilitating user–service provider interactions using an insights engine framework, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

As described briefly above, existing user interaction systems lack the capability to autonomously determine the intent, the sentiment, or the behavioral patterns of users when connecting with such users with human service provider agents to address queries that are sent by the users. Such systems further lack the capability to autonomously identify issues with services provided to the users (or to their equipment) and to autonomously initiate actions to address such issues.

The present technology provides for an insights engine framework that is used to facilitate service provisioning as well as facilitating interactions between users and service providers. In some aspects, a computing system may receive, from a user device associated with a first user, one or more queries regarding a first service provided by a service provider, and may receive user interaction data associated with the first user. The computing system may predict at least one intent of the first user, by analyzing at least one of the one or more queries or the user interaction data, in some cases, using an artificial intelligence ("AI") model. The computing system may access historical and current records of issues with a plurality of services provisioned to a plurality of users within a geographic area in which the first service is provided to the first user. The computing system may identify at least one of one or more current issues with the first service provided to the first user or one or more potential future issues with the first service provided to the first user, based on the predicted at least one intent of the first user, and based on the historical and current records of issues with the plurality of services provisioned to the plurality of users within the geographic area. The computing system may autonomously perform one or more actions (e.g., implementing updates or upgrades to equipment providing the first service, and/or ordering new equipment and dispatching technicians to install the new equipment, etc.) to address the identified at least one of the one or more current issues with the first service provided to the first user or the one or more potential future issues with the first service provided to the first user.

In other aspects, the computing system may calculate user engagement metrics associated with the first user, based on the user interaction data, and may calculate a user engagement index associated with the first user, based on the user engagement metrics. The computing system may predict one or more of at least one intent, at least one sentiment, or at least one behavioral pattern of the first user, by analyzing at least one of the one or more queries or the user interaction data, in some cases, using an AI model. The computing system may autonomously match the first user with one or more service provider agents among a plurality of service provider agents, based on a combination of the user engagement index, a plurality of agent capability scores associated with the plurality of service provider agents, and the predicted one or more of the at least one intent, the at least one sentiment, or the at least one behavioral pattern of the first user. The computing system may autonomously route a communication line that connects the first user to a first available service provider agent among the one or more service provider agents.

In the manner above, the system as described herein enables autonomous identification of issues with services provided to users, based on AI analysis, and provides for autonomously initiation of actions to address the identified issues. In this way, issues may be addressed before such issues escalate to become wide-spread and/or to improve the operation of the equipment providing services to users. In terms of service provider agent interactions with users, the system as described herein also enables smart routing of queries and communications from users to human service provider agents, based on analysis (in some cases, AI analysis) of the intent(s), the sentiment(s), and/or behavioral patterns of users as well as analysis of capabilities and skills of the plurality service provider agents. In this way, the human service provider agents with the requisite skills and capabilities are matched with the users to ensure that issues are resolved in an efficient manner while improving relationships between the users and the service provider. In particular, the present technology provides an improvement to user interface or interaction systems in terms of its capability in identifying intent, sentiment, and/or behavioral patterns of users, while also identifying and predicting issues with services, and providing action plans to address issues. The user interface or interaction systems are also improved in terms of dynamically connecting, routing, and/or matching users with appropriately qualified or skilled human service provider agents to handle interactions, based on the identified intent, sentiment, and/or behavioral patterns of the users.

These and other aspects of the systems and methods for facilitating user–service provider interactions using an insights engine framework are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system and from a user device associated with a first user, one or more queries regarding a first service provided by a service provider; receiving, by the computing system, user interaction data associated with the first user; predicting, by the computing system, at least one intent of the first user, by analyzing at least one of the one or more queries or the user interaction data; accessing, by the computing system, historical and current records of issues with a plurality of services provisioned to a plurality of users within a geographic area in which the first service is provided to the first user; identifying, by the computing system, at least one of one or more current issues with the first service provided to the first user or one or more potential future issues with the first service provided to the first user, based on the predicted at least one intent of the first user, and based on the historical and current records of issues with the plurality of services provisioned to the plurality of users within the geographic area; and autonomously performing, by the computing system, one or more actions to address the identified at least one of the one or more current issues with the first service provided to the first user or the one or more potential future issues with the first service provided to the first user.

In another aspect, the technology relates to a system, including a computing system and memory coupled to the computing system. The memory includes computer executable instructions that, when executed by the computing system, causes the computing system to perform operations including: receiving, from a user device associated with a first user, one or more queries regarding a first service provided by a service provider; receiving user interaction data associated with the first user; predicting at least one intent of the first user, by analyzing at least one of the one or more queries or the user interaction data; accessing historical and current records of issues with a plurality of services provisioned to a plurality of users within a geographic area in which the first service is provided to the first user; identifying at least one of one or more current issues with the first service provided to the first user or one or more potential future issues with the first service provided to the first user, based on the predicted at least one intent of the first user, and based on the historical and current records of issues with the plurality of services provisioned to the plurality of users within the geographic area; and autonomously performing one or more actions to address the identified at least one of the one or more current issues with the first service provided to the first user or the one or more potential future issues with the first service provided to the first user.

In yet another aspect, the technology relates to a method, including receiving, by a computing system and from a user device associated with a first user, one or more queries regarding a first service provided by a service provider; receiving, by the computing system, user interaction data associated with the first user; calculating, by the computing system, user engagement metrics associated with the first user, based on the user interaction data; calculating, by the computing system, a user engagement index associated with the first user, based on the user engagement metrics; predicting, by the computing system, one or more of at least one intent, at least one sentiment, or at least one behavioral pattern of the first user, by analyzing at least one of the one or more queries or the user interaction data; autonomously matching, by the computing system, the first user with one or more service provider agents among a plurality of service provider agents, based on a combination of the user engagement index, a plurality of agent capability scores associated with the plurality of service provider agents, and the predicted one or more of the at least one intent, the at least one sentiment, or the at least one behavioral pattern of the first user; and autonomously routing, by the computing system, a communication line that connects the first user to a first available service provider agent among the one or more service provider agents.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

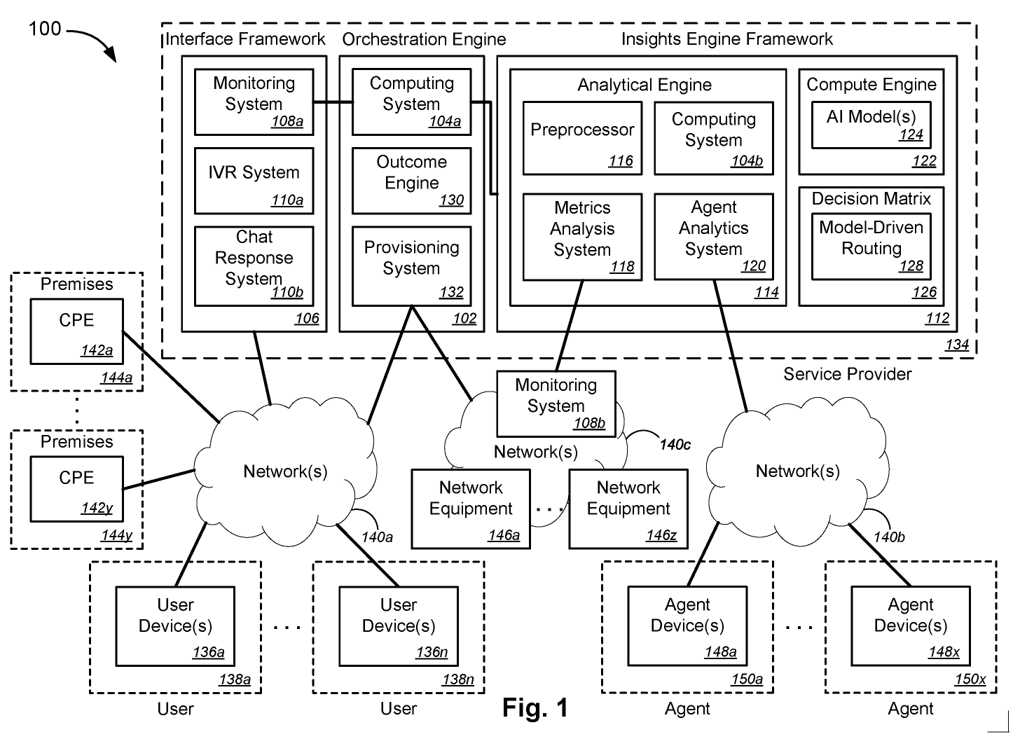

Turning to the embodiments as illustrated by the drawings, FIGS. 1-5 illustrate some of the features of methods, systems, and apparatuses for facilitating user–service provider interactions using an insights engine framework, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for facilitating service provisioning and user–service provider interactions using an insights engine framework, in accordance with various embodiments.

In the non-limiting embodiment of FIG. 1, system 100 may include at least one of an orchestration engine 102, a computing system 104a and/or 104b, an interface framework 106, a monitoring system 108a or 108b, an IVR system 110a, a chat response system 110b, an insights engine framework 112, an analytical engine 114, a preprocessor 116, a metrics analysis system 118, an agent analytics system 120, an AI compute engine 122 that uses and/or trains one or more AI models 124, a decision matrix 126, a model-driven routing system 128, an outcome engine 130, or a provisioning system 132, and/or the like. In some examples, the orchestration engine 102 may include at least one of the computing system 104a, the outcome engine 130, or the provisioning system 132, and/or the like. In some cases, the interface framework 106 may include at least one of the monitoring system 108a, the IVR system 110a, and/or the chat response system 110b, and/or the like. In some instances, the insights engine framework 112 may include the analytical engine 114, the AI compute engine 122, and the decision matrix 126. In examples, the analytical engine 114 may include at least one of the computing system 104b, the preprocessor 116, the metrics analysis system 118, or the agent analytics system 120, and/or the like. In some examples, the orchestration engine 102, the interface framework 106, and the insights engine framework 112 (and subcomponents of each of these components) may include be owned, managed, and/or operated by a service provider 134.

The system 100 may further include a plurality of user devices 136a-136n (collectively, "user devices 136" or the like) that is associated with a plurality of users 138a-138n (collectively, "users 138" or the like), one or more networks 140a-140c (collectively, "networks 140" or the like), and a plurality of CPE 142a-142y (collectively, "CPE 142" or the like) that is disposed at a corresponding plurality of premises 144a-144y (collectively, "premises 144" or the like). In examples, the system 100 may further include a plurality of network equipment 146a-146z (collectively, "network equipment 146" or the like). In some examples, the system 100 may further include a plurality of agent devices 148a-148x (collectively, "agent devices 148" or the like) that is associated with a corresponding plurality of service provider agents 150a-150x (collectively, "agents 150" or "service provider agents 150" or the like). Herein, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some instances, the plurality of user devices 136a-136n may each include, but is not limited to, one of a desktop computer, a laptop computer, a tablet computer, a smart phone, or a mobile phone, or the like. In some cases, the plurality of users 138a-138n may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some cases, the plurality of premises 144a-144y may each include, but is not limited to, one of a residential customer premises, a business customer premises, a corporate customer premises, an enterprise customer premises, an education facility customer premises, a medical facility customer premises, or a governmental customer premises, and/or the like.

According to some embodiments, unless otherwise indicated, networks 140a-140c may each include, without limitation, one of a local area network ("LAN"), including, without limitation, a fiber network, an Ethernet network, a Token-Ring™network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 140a-140c may include an access network of the service provider (e.g., an Internet service provider ("ISP")). In another embodiment, the networks 140a-140c may include a core network of the service provider and/or the Internet.

In some aspects, when a user 138, among the plurality of users 138a-138n, interacts with the IVR system 110a or the chat response system 110b of the interface framework 106, via a corresponding user device 136, among the plurality of user devices 136a-136n, and via network(s) 140a, the monitoring system 108a may monitor and record user interaction data associated with the user 138. In some examples, the user interaction data associated with the user 138 may include at least one of voice interactions with the IVR system 110a, voice interactions with human service provider agents (e.g., one or more agents 150a-150x, or the like) via agent devices (e.g., corresponding one or more agent devices 148a-148x, or the like), or text-based chat interactions with the chat response system 110b (including text-based automated chat interactions with an automated chat response system and/or text-based chat interactions with human service provider agents via the chat response system), and/or the like. In some cases, the monitoring system 108a may also monitor and record one or more historical and current records of issues, which may include at least one of historical interactions between the user 138 and service provider agents 150 of the service provider 134, previous issues associated with service(s) provided to the user 138, or previous or current issues associated with similar services provided to the plurality of users 138a-138n within a geographic area in which the service(s) is provided to the user 138, and/or the like.

In examples, the orchestration engine 102 and/or the computing system 104a may retrieve, receive, and/or access the user interaction data and/or the one or more historical and current records of issues (collectively, "user input parameters" or the like), and may relay the user input parameters to the insights engine framework 112 and/or the analytical engine 114 thereof. The computing system 104b and/or the preprocessor 116 may analyze the user input parameters. In some examples, the user input parameters may further include user engagement metrics including at least one of previous interaction times between the user 138 and service provider agents 150 of the service provider 134, a length of time during which the user 138 is a customer of the service provider 134, total revenue that is generated from the user 138 over the length of time, and/or user ratings of interactions between the user 138 and service provider agents 150, and/or the like. In examples, the orchestration engine 102 and/or the computing system 104a may preprocess and/or analyze one or more of the user input parameters to generate insights including at least one of an interaction frequency between the user 138 and service provider agents 150, a pattern of interactions between the user 138 and service provider agents 150, and/or a customer lifetime value ("CLV") or a lifecycle value associated with the user, and/or the like. In some cases, the user input parameters may further include

In some examples, the insights engine framework 112, the analytical engine 114 thereof, and/or components of the analytical engine 114 (including the computing system 104b and/or the agent analytics system 120, or the like) may receive agent performance data associated with the plurality of service provider agents 150a-150x, and may calculate or compile agent capability metrics associated with each of the plurality of service provider agents 150a-150x based on corresponding agent performance data for each of the plurality of service provider agents 150a-150x. In examples, the agent performance data (also referred to herein as "agent input parameters" or the like) for each service provider agent 150 among the plurality of service provider agents 150a-150x may include, for that service provider agent 150, at least one of an average net promoter score, a resolution ratio or first contact resolution ("FCR") score, an adjustments per contact score, user/customer survey results, or a conversion average handle time ("AHT"), and/or the like. In some examples, the insights engine framework 112, the analytical engine 114 thereof, and/or components of the analytical engine 114 (including the computing system 104b and/or the agent analytics system 120, or the like) may calculate an agent capability index for each service provider agent 150, based on the agent performance data for that service provider agent 150.

As used herein, the net promoter score may refer to a metric that measures how likely customers are to recommend a company or its products or services, and is a key performance indicator ("KPI") used to gauge customer satisfaction and loyalty. KPI may refer to a quantifiable measure of performance over time for a specific objective, and examples of KPIs may include revenue growth, revenue per customer, profit margin, customer retention rate, and/or customer satisfaction, and/or the like. An FCR score, as used herein, may refer to a metric that measures how many customer interactions are resolved on the first attempt, and may be calculated by dividing the number of resolved interactions by the total number of interactions, then multiplying by 100. As used herein, an adjustments per contact score may refer to the number of times a customer interaction needs to be modified or escalated to reach a resolution, essentially indicating how many adjustments are required per customer contact to successfully handle their issue; a lower number signifies more efficient customer service where issues can be resolved with minimal adjustments needed. A conversion AHT, as used herein, may refer to the average time that is used to complete a customer interaction that results in a desired action (e.g., a purchase, signing up for a service, or resolving an issue, etc.) as opposed to just a general customer service call.

In examples, the insights engine framework 112, the analytical engine 114, the AI compute engine 122, and/or components of the analytical engine 114 (including the computing system 104b and/or the metrics analytics system 118, or the like) may analyze at least one of the one or more queries or the user interaction data to predict one or more of: (a) at least one intent of user 138, using intent analysis using AI model(s) 124 and/or machine learning ("ML") algorithms; (b) at least one sentiment of user 138, using sentiment analysis using AI model(s) 124 and/or ML algorithms; and/or (c) at least one behavioral pattern of user 138, using behavioral analysis using AI model(s) 124 and/or ML algorithms. In examples, the intent analysis may identify the purpose or goal behind the interaction (i.e., the reason that the user 138 initiated the interaction by sending the queries). In some examples, the sentiment analysis may utilize natural language processing ("NLP") to identify the sentiment of specific aspects of the interaction, in some cases, from at least one of speech patterns, intonations, interruptions, silences, pauses, use of particular words, use of particular phrases, sequences of words, or sequences of phrases, and/or the like, by the user 138 during the interaction(s). In the case that the interaction(s) includes a video communication(s), the sentiment analysis may identify the sentiment of specific aspects of the interaction, in some cases, from at least one of turns, gestures, speech patterns, intonations, interruptions, silences, pauses, use of particular looks, use of particular facial expressions, use of particular words, use of particular phrases, sequences of words, or sequences of phrases, and/or the like, by the user 138 during the video communication(s). In examples, the behavioral analysis may include developing a behavioral model and/or a user psyche for the user 138, in some cases, based on conversation analysis of the interaction(s) to identify behavioral patterns of the user 138 from at least one of speech patterns, intonations, interruptions, silences, pauses, use of particular words, use of particular phrases, sequences of words, or sequences of phrases, and/or the like, by the user 138 during the interaction(s). In the case that the interaction(s) includes a video communication(s), the behavioral analysis may identify the behavioral patterns of the user 138, in some cases, from at least one of turns, gestures, speech patterns, intonations, interruptions, silences, pauses, use of particular looks, use of particular facial expressions, use of particular words, use of particular phrases, sequences of words, or sequences of phrases, and/or the like, by the user 138 during the video communication(s).

In some examples, the insights engine framework 112, the analytical engine 114, the AI compute engine 122, and/or components of the analytical engine 114 (including the computing system 104b and/or the metrics analytics system 118, or the like) may calculate a user engagement index associated with user 138, based on the user input parameters and/or the user engagement metrics. In some cases, the user engagement index may be calculated using one or more logistic regression algorithms based on the user input parameters and/or the user engagement metrics. In an example, the user engagement index may include percentage ranges including a first range of percentage values greater than about 75 % indicating low difficulty in terms of interactions between the service provider agents and the user 138, a second range of percentage values greater than about 25 % or greater than about 50 % and less than about 75 % indicating medium difficulty in terms of interactions between the service provider and the user 138, or a third range of percentage values less than about 25 % indicating high difficulty in terms of interactions between the service provider and the user 138, or the like. Alternatively, in another example, tiers of value ranges of any suitable value, a first tier indicating low difficulty in terms of interactions between the service provider agents and the user 138, a second tier indicating medium difficulty in terms of interactions between the service provider and the user 138, or a third tier indicating high difficulty in terms of interactions between the service provider and the user 138, or the like. In some cases, the low difficulty in terms of interactions may correspond to an excellent or positive sentiment of the user 138 toward the service provider 134, while the high difficulty in terms of interactions may correspond to a poor or negative sentiment (and potential risk of the user stopping use of the service provided by the service provider) of the user 138 toward the service provider 134, and the medium difficulty in terms of interactions may correspond to a neutral sentiment of the user 138 toward the service provider 134. In some instances, the sentiment levels may be represented by ranges of score values (e.g., between 1 and 10, with 1 representing a negative sentiment and 10 representing a positive sentiment, and values in between corresponding to a sliding scale therebetween, or the like).

In examples, the insights engine framework 112, the analytical engine 114, the AI compute engine 122, and/or components of the analytical engine 114 (including the computing system 104b and/or the metrics analytics system 118, or the like) may categorize user engagement into a categorized engagement level of a plurality of engagement levels, based on the user engagement index, the plurality of engagement levels corresponding to a level of potential difficulty in terms of interactions between the first user and service provider agents. In some examples, while the user engagement index is a value, the categorized engagement level may include the descriptions or definitions of the difficulty levels corresponding to the value of the user engagement index. For instance, a categorized engagement level of negative sentiment and/or high difficulty in terms of interactions between user 138 and service provider agents 150 may correspond to a value below about 25 % on a percentage-based scale or between 1 and about 3 on a 10-point scale for a user engagement index for that user 138. Similarly, a categorized engagement level of neutral sentiment and/or medium difficulty in terms of interactions between user 138 and service provider agents 150 may correspond to a value between about 25 % and about 75 % (or between about 25 % and about 50 %, or between about 50 % and about 75 %) on a percentage-based scale or between about 4 and about 7 on a 10-point scale for a user engagement index for that user 138. Likewise, a categorized engagement level of positive sentiment and/or low difficulty in terms of interactions between user 138 and service provider agents 150 may correspond to a value greater than about 75 % on a percentage-based scale or between about 8 and 10 on a 10-point scale for a user engagement index for that user 138.

In some examples, the insights engine framework 112, the analytical engine 114, the AI compute engine 122, the decision matrix 126, and/or components of the analytical engine 114 (including the computing system 104b and/or the agent analytics system 120, or the like) may autonomously match the user 138 and one or more service provider agents 150 among the plurality of agents 150a-150x, based on a combination of the user engagement index and the agent capability index for each of a plurality of service provider agents 150a-150x, in some cases, further based on a predicted one or more of the at least one intent, the at least one sentiment, or the at least one behavioral pattern of the user 138, and/or the like. In examples, the orchestration engine 102, the computing system 104a, the outcome engine 130, and/or the provisioning system 132 may autonomously route a communication line that connects the user 138 and an available service provider agent among the one or more service provider agents 150 (e.g., a first service provider agent among the one or more service provider agents 150, in some cases, where the one or more system agents 150 have been added to an agent queue for the user 138, or the like).

In another aspect, the monitoring system 108b may monitor and record network performance data associated with a plurality of services being provided by the plurality of network 146a-146z and/or associated with the plurality of CPE 142a-142y. In some examples, the insights engine framework 112, the analytical engine 114 thereof, and/or components of the analytical engine 114 (including the computing system 104b and/or the metrics analytics system 118, or the like) may receive or access historical and current records of issues with the plurality of services provisioned to the plurality of users 138a-138n and/or the plurality of CPE 142a-142y each associated with a corresponding one of the plurality of users 138a-138n. In some cases, the insights engine framework 112, the analytical engine 114 thereof, and/or components of the analytical engine 114 (including the computing system 104b and/or the metrics analytics system 118, or the like) may identify at least one of one or more current issues and/or one or more potential future issues with service provided to user 138 (and the CPE 142 associated with user 138), in some cases, based on analysis of the historical and current records of issues with one or more services provisioned to one or more users 138 and/or corresponding one or more CPE 142 that are within a geographic area in which the service is provided to user 138 and corresponding CPE 142. In examples, the orchestration engine 102 and/or the computing system 104a may retrieve, receive, and/or access the at least one of the one or more current issues and/or the one or more potential future issues, and may autonomously perform one or more actions to address the at least one of the one or more current issues and/or the one or more potential future issues with service provided to user 138 (and the CPE 142 associated with user 138). In examples, the one or more actions may include the orchestration engine 102 and/or the computing system 104 performing at least one of: (a) autonomously implementing one or more updates to equipment (e.g., one of network equipment 146a-146z, or the like) providing the service to user 138 (and the CPE 142 associated with user 138); (b) autonomously implementing one or more upgrades to the equipment providing the service to user 138 (and the CPE 142 associated with user 138); or (c) autonomously ordering new equipment to replace existing equipment providing the service to user 138 (and the CPE 142 associated with user 138), and dispatching technicians to install the new equipment; and/or the like.

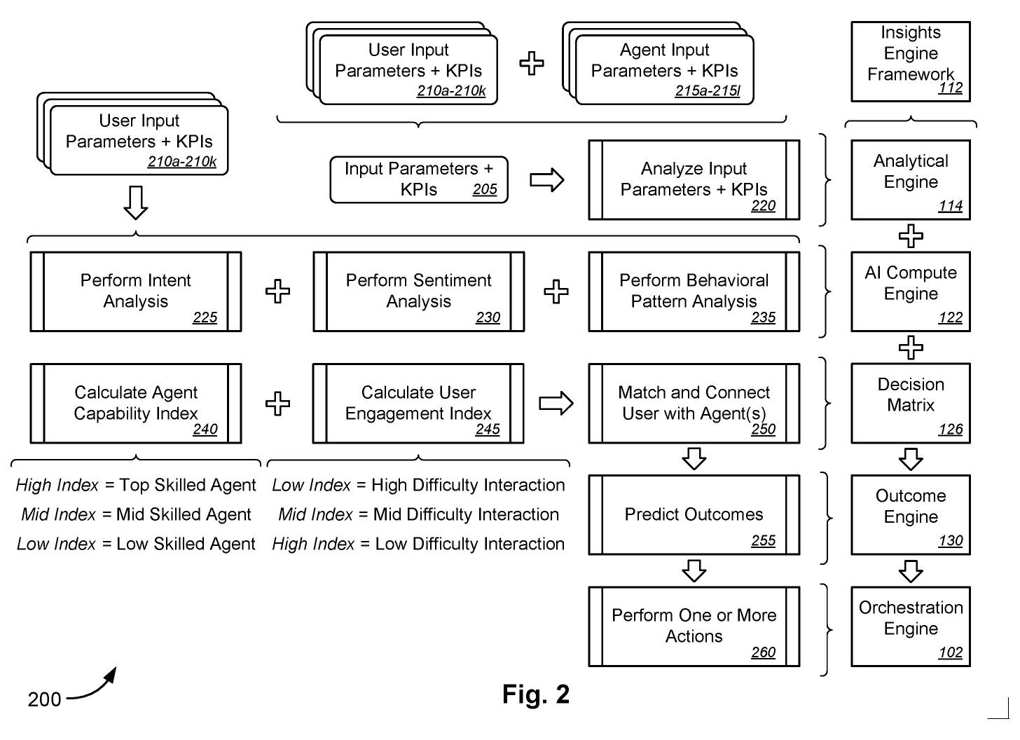

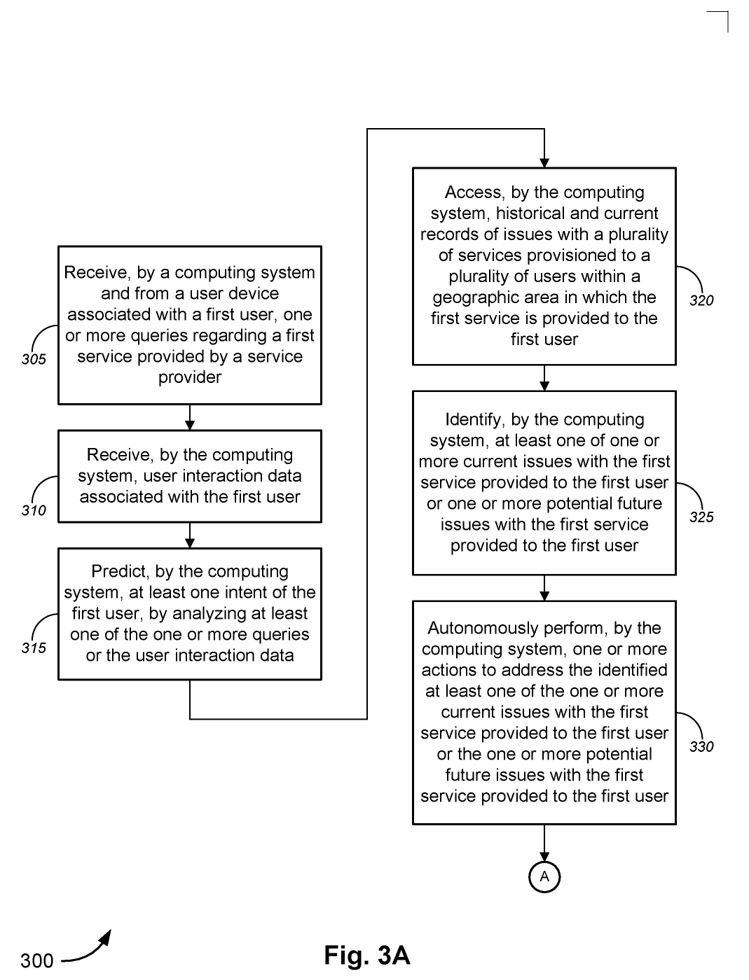

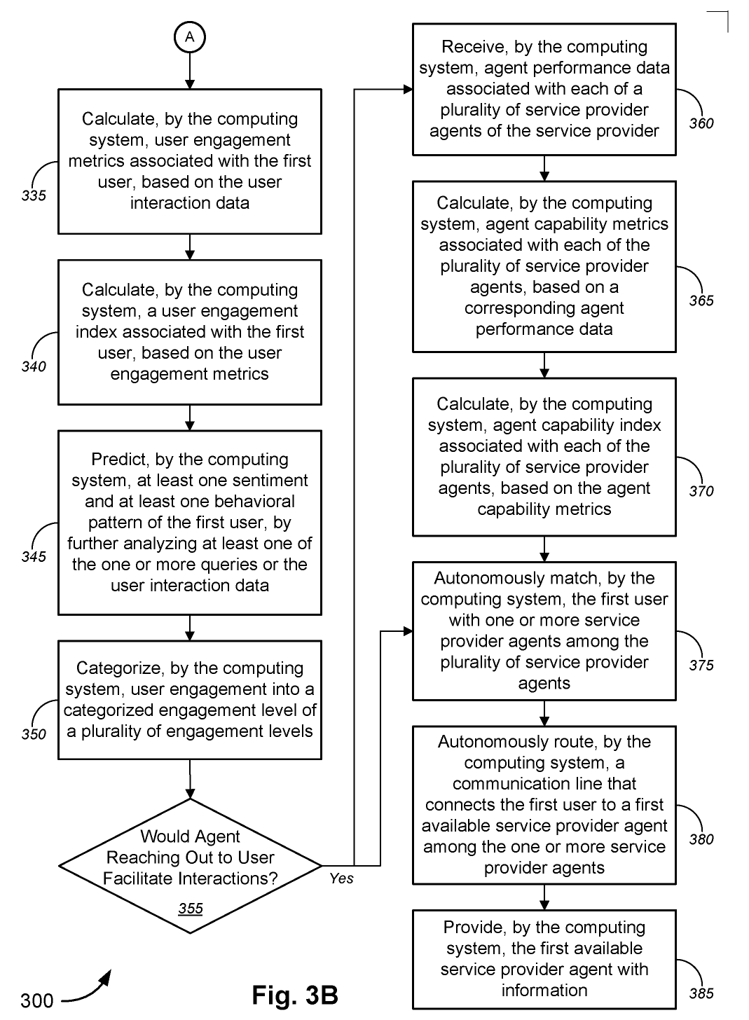

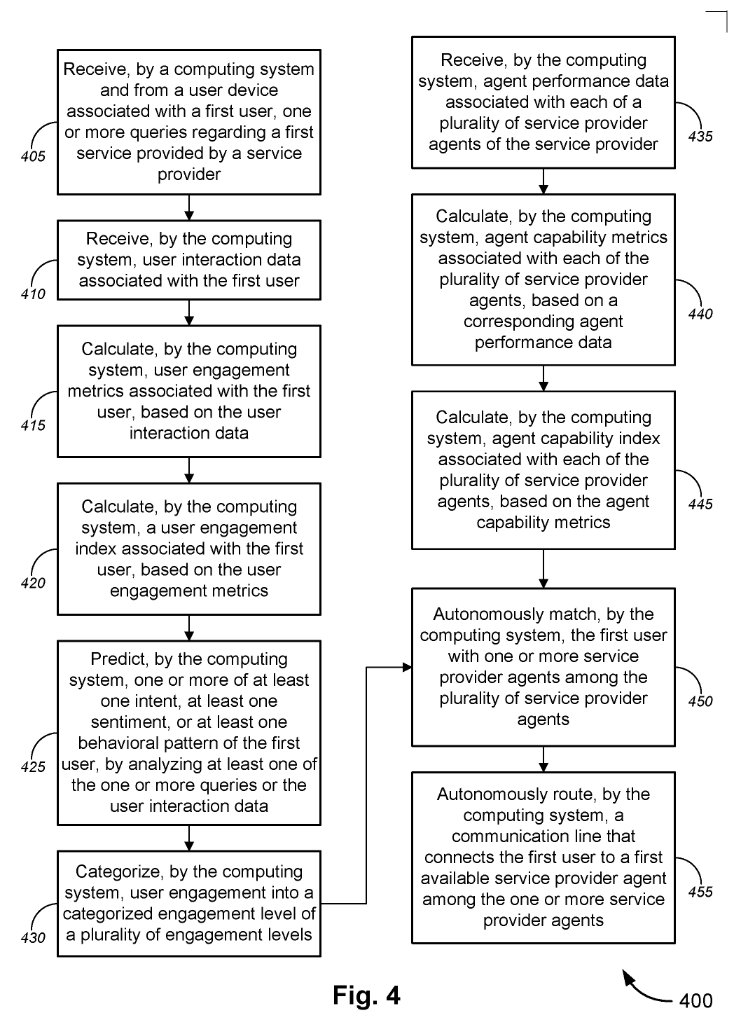

In operation, the orchestration engine 102, the insights engine framework 112, computing system 104a or 104b, analytical engine 114, preprocessor 116, metrics analysis system 118, agent analytics system 120, AI compute engine 122, decision matrix 126, outcome engine 130, and/or provisioning system 132 (collectively, "computing system") may perform methods for facilitating service provisioning and user–service provider interactions using an insights engine framework, as described in detail with respect to FIGS. 2-4. For example, example sequence flows 200 as described below with respect to FIG. 2, and methods 300 and 400 as described below with respect to FIGS. 3A-3B and 4 may be applied with respect to the operations of system 100 of FIG. 1. Although the examples of FIGS. 1-4 are described herein with respect to telecommunications services, the various embodiments are not so limited, and at least the user/agent matching functionality may be applied to any industry and situation in which customers/clients/users/patients are to be matched with service agents or any service provider or entity to address issues and/or queries with products and/or services provided to the customers/clients/users/patients, and/or where there is a likelihood of the customers/clients/users/patients stopping use of such products and/or services (also referred to as "churn risk"). For example, the various embodiments may be applicable to the consumer electronics industry, the home appliance industry, the office equipment industry, the vehicle industry, the cloud service industry, and so on. Where autonomous implementation of remedies (e.g., repairs, reconfigurations, software/firmware updates, replacements, ordering of components/replacements, etc.) may be affected for any of these other industries, the autonomous actions of the outcome engine and/or the orchestration engine may also be applicable.

FIG. 2 depicts an example sequence flow 200 for facilitating service provisioning and user–service provider interactions using an insights engine framework, in accordance with various embodiments. In some embodiments, insights engine framework 112, analytical engine 114, AI compute engine 122, decision matrix 126, outcome engine 130, and orchestration engine 102 of FIG. 2 may be similar, if not identical, to the insights engine framework 112, analytical engine 114, AI compute engine 122, decision matrix 126, outcome engine 130, and orchestration engine 102, respectively, of system 100 of FIG. 1, and the description of these components of system 100 of FIG. 1 are similarly applicable to the corresponding components of FIG. 2.

In examples, the insights engine framework 112 may receive input parameters and KPIs 205 (collectively, "input parameters 205") that include one or more of a set of user input parameters and KPIs 210a-210k (collectively, "user input parameters 210") and a set of agent input parameters and KPIs 215a-215l (collectively, "agent input parameters 215"). The insights engine framework 112 may utilize the analytical engine 114 to analyze the input parameters 205-215 and/or portions thereof (e.g., user input parameters 210 and/or agent input parameters 215, or the like) (at operation 220). In some examples, the user input parameters 210 may include user engagement metrics including at least one of previous interaction times between a user (e.g., user 138 among the plurality of users 138a-138n of FIG. 1, or the like) and service provider agents of the service provider (e.g., one or more service provider agents 150 among the plurality of service provider agents 150a-150x of service provider 134 of FIG. 1, or the like), a length of time during which the user is a customer of the service provider, total revenue that is generated from the user over the length of time, and/or user ratings of interactions between the user and the service provider agents, and/or the like. In examples, the insights engine framework 112 and/or the analytical engine 114 may preprocess and/or analyze one or more of the user input parameters 210 to generate insights (also referred to as "analytical data") including at least one of an interaction frequency between the user and the service provider agents, a pattern of interactions between the user and the service provider agents, and/or a CLV or a lifecycle value associated with the user, and/or the like.

In some examples, the insights engine framework 112 and/or the AI compute engine 122 may enhance analytical data associated with a user (e.g., user 138 among the plurality of users 138a-138n, or the like) or service provisioned to the user (or a CPE associated with the user) that may include at least one of performing intent analysis to identify an intent(s) of the user (at operation 225), performing sentiment analysis to identify a sentiment(s) of the user (at operation 230), and/or performing behavioral pattern analysis to identify a behavioral model and a customer psyche for the user (at operation 235). In some cases, the sentiment analysis may include using AI models (e.g., AI model(s) 124 of FIG. 1, or the like) and/or AI libraries, frameworks, or tools. In some instances, the behavioral pattern analysis may use AI libraries to generate the behavioral model and the customer psyche for the user. In examples, the AI compute engine 122 may leverage advanced AI and ML algorithms or models (e.g., support vector machine ("SVM"), bidirectional encoder representations from transformers ("BERT"), etc.) for intent analysis (at operation 225), sentiment analysis (at operation 230), and/or behavioral pattern analysis (at operation 235). In this manner, the insights engine framework 112 may provide for a deeper understanding of user/customer behavior and psyche, which may be used to enhance personalized user/customer engagement.

In examples, at operation 240, the insights engine framework 112 and/or the decision matrix 126 may calculate an agent capability index based on the agent input parameters 215 or outputs of the analysis of the agent input parameters 215 (from operation 220). In some cases, the agent capability index may be categorized into one of a high agent index value (or range) corresponding to a top skilled agent, a mid or medium agent index value (or range) corresponding to a mid or medium skilled agent, or a low agent index value (or range) corresponding to a low skilled agent, where the skill levels of the agent are with respect to capability of the agent to handle interactions with users, particularly difficult users. Alternatively or additionally, at operation 245, the insights engine framework 112 and/or the decision matrix 126 may calculate a user engagement index, based on a combination of one or more input parameters among the user input parameters 210, the intent(s) of the user, the sentiment(s) of the user, and/or the behavioral model and the customer psyche for the user, and/or the like. In some instances, the user engagement index may be categorized into one of a low user index value (or range) corresponding to a user likely to cause high difficulty interactions with service provider agents, a mid or medium user index value (or range) corresponding to a user likely to cause mid or medium difficulty interactions with service provider agents, or a high user index value (or range) corresponding to a user likely to cause low difficulty interactions with service provider agents.

In some examples, at operation 250, the insights engine framework 112 and/or the decision matrix 126 may match the user with one or more agents based on a combination of the categorized agent capability index and the categorized user engagement index. The insights engine framework 112 and/or the decision matrix 126 may then assign an agent, among the one or more agents, who is currently available or first in a queue of available agents among the one or more agents, and may connect the user with the assigned agent, in some cases, using behavior model driven smart routing. In particular, top skilled agents (e.g., agents having a high agent index value or range) may be matched with a user likely to cause high difficulty interactions with service provider agents (e.g., a user having a low user index value or range), as such top skilled agents are deemed, or have been proven or shown, to be capable of successfully interacting with such high difficulty users. In some cases, mid or medium skilled agents (e.g., agents having a mid or medium agent index value or range) may be matched with a user likely to cause mid or medium difficulty interactions with service provider agents (e.g., a user having a mid or medium user index value or range), as such mid or medium skilled agents are deemed, or have been proven or shown, to be capable of successfully interacting with such mid or medium difficulty users, but have not yet been proven to successfully interact with high difficulty users. In some instances, low skilled agents (e.g., agents having a low agent index value or range) may be matched with a user likely to cause low difficulty interactions with service provider agents (e.g., a user having a high user index value or range), as such low skilled agents have not yet been proven to successfully interact with high difficulty users or with mid or medium difficulty users.

In some examples, the insights engine framework 112 and/or the decision matrix 126 may generate a list of issues and may prioritize issues for addressing, using matrix calculations based on determined impact and relevance, in some cases, further based on observations from previous phases (e.g., based on the input parameters 205, user input parameters 210, agent input parameters 215, the insights or analytical data from the analytical engine 114, the intent(s) of the user, the sentiment(s) of the user, and/or the behavioral model and the customer psyche for the user, or the like). In some cases, the insights engine framework 112 and/or the decision matrix 126 may identify the most critical areas needing attention and may ensure efficient resource allocation. In an example, the insights engine framework 112 and/or the decision matrix 126 may perform multi-factor decision making by impact and relevance analysis ("MFDIR") corresponding to a structured approach that is used to evaluate and rank multiple alternatives based on various criteria, and may be used to assist in making informed decisions by considering the impact and relevance of each criterion.

In examples, the outcome engine 130 may identify one or more outcomes, including retention ratio, revenue scope, etc. In some examples, instead of the decision matrix 126 calculating the agent capability index (at operation 240), calculating the user engagement index (at operation 245), and/or matching and connecting the user with agent(s) (at operation 250), the outcome engine 130 may perform these operations. In some cases, at operation 255, the outcome engine 130 may predict (and share) outcomes each in one of three formats: (1) technical outcomes (e.g., outcomes related to the technical remedies for addressing technical issues with provisioning the service to the user or CPE associated with the user, or the like); (2) business outcomes (e.g., outcomes related to improving business processes (e.g., account management, invoicing, and/or inventory management, or the like)); and (3) sales outcomes (e.g., outcomes related to improving sales to users or customers, or the like); and/or the like. In some examples, the predicted outcomes may correspond to current issues and/or potential future issues with the service provided to the user (or the CPE associated with the user) that are, in some cases, further categorized into the three formats above. In some instances, the outcome engine 130 may provide a clear understanding of the potential impacts and benefits of the generated insights.

In some examples, the orchestration engine 102 may automatically handle final actions and may link tools, and action plans, to agents. In some cases, the orchestration engine 102 may ensure that insights and recommendations are seamlessly integrated into a company's workflow, enabling prompt and effective responses to customer needs. In examples, the orchestration engine 102 may autonomously perform one or more actions to address the identified at least one of the one or more current issues with the first service provided to the first user or the one or more potential future issues with the first service provided to the first user. In examples, the one or more actions may include the orchestration engine 102 performing at least one of: (a) autonomously implementing one or more updates to equipment (e.g., one of network equipment 146a-146z of FIG. 1, or the like) providing the service; (b) autonomously implementing one or more upgrades to the equipment providing the service; or (c) autonomously ordering new equipment to replace existing equipment providing the service, and dispatching technicians to install the new equipment; and/or the like. Alternatively or additionally, the one or more actions may further include the orchestration engine 102 linking to a business process management system and/or creating a business issue tracking feature to track the issue, creating a project management feature to manage projects, and/or using a reporting feature to report issues and project statuses, and/or the like. Alternatively or additionally, the one or more actions may further include the orchestration engine 102 creating personalized action plans for particular users/customers and sending to sales agents (in some cases, directed at former users/customers and/or at new users/customers, etc.).

In examples, when multiple users or customers are concurrently sending requests and/or queries to the service provider, the multiple users are slotted into a user queue, and each user's user engagement index is determined as described in detail herein. The behavior model driven smart routing (as described above) may be used to implement an intelligent routing system that matches the users or customers to the agents having the capability to successfully interact with the users (e.g., based on the agent capability index for each agent among the plurality of service provider agents, or the like), in some cases, based on a combination of the intent(s), sentiment(s), and behavior pattern(s) of the user, and not just because of the queue of the user matching with the queue of random agents in general.

FIGS. 3A and 3B (collectively, "FIG. 3") depict flow diagrams illustrating an example method 300 for facilitating service provisioning and user–service provider interactions using an insights engine framework, in accordance with various embodiments. With reference to FIGS. 3A and 3B, the operations of example method 300 may be performed by one or more of an orchestration engine (e.g., orchestration engine 102 of FIG. 1, or the like), an insights engine framework (e.g., insights engine framework 112 of FIG. 1, or the like), and/or components thereof (e.g., computing system 104a or 104b, analytical engine 114, preprocessor 116, metrics analysis system 118, agent analytics system 120, AI compute engine 122, decision matrix 126, outcome engine 130, and/or provisioning system 132 of FIG. 1, or the like) (in some cases, collectively referred to herein as "computing system"). Method 300 of FIG. 3A may continue onto FIG. 3B following the circular marker denoted, "A."

In the example method 300 of FIG. 3A, at operation 305, a computing system may receive, from a user device (e.g., one of user devices 136a-136n of FIG. 1, or the like) associated with a first user (e.g., one of users 138a-138n of FIG. 1, or the like), one or more queries regarding a first service provided by a service provider (e.g., service provider 134 of FIG. 1, or the like). At operation 310, the computing system may receive user interaction data associated with the first user. In examples, the first service may be provisioned to a first CPE at a first premises (e.g., CPE 142 among CPE 142a-142y located at premises 144a-144y of FIG. 1, or the like) and/or at one or more network equipment (e.g., one or more network equipment 146 among a plurality of network equipment 146a-146z of FIG. 1, or the like). In some examples, the at least one of the one or more queries or the user interaction data may be analyzed using NLP. In some instances, the one or more of the at least one intent, the at least one sentiment, or the at least one behavioral pattern of the first user may be predicted using one or more AI models (e.g., one or more AI models 124 of FIG. 1, or the like). At operation 315, the computing system may predict at least one intent of the first user, by analyzing at least one of the one or more queries or the user interaction data. At operation 320, the computing system may access historical and current records of issues with a plurality of services provisioned to a plurality of users (e.g., the plurality of users 138a-138n of FIG. 1, or the like) within a geographic area in which the first service is provided to the first user. At operation 325, the computing system may identify at least one of one or more current issues with the first service provided to the first user or one or more potential future issues with the first service provided to the first user, in some cases, based on the predicted at least one intent of the first user, and based on the historical and current records of issues with the plurality of services provisioned to the plurality of users within the geographic area. At operation 330, the computing system may autonomously perform one or more actions to address the identified at least one of the one or more current issues with the first service provided to the first user or the one or more potential future issues with the first service provided to the first user. In examples, the one or more actions may include the computing system performing at least one of: (a) autonomously implementing one or more updates to equipment (e.g., one of network equipment 146a-146z of FIG. 1, or the like) providing the first service; (b) autonomously implementing one or more upgrades to the equipment providing the first service; or (c) autonomously ordering new equipment to replace existing equipment providing the first service, and dispatching technicians to install the new equipment; and/or the like.

In some examples, the user interaction data may include at least one of voice interactions with an IVR system (e.g., IVR system 110a of FIG. 1, or the like), voice interactions with human service provider agents (e.g., one or more agents 150a-150x of FIG. 1, or the like), text-based automated chat interactions with an automated chat response system (e.g., chat response system 110b of FIG. 1, or the like), or text-based chat interactions with human service provider agents via a chat response system (e.g., chat response system 110b of FIG. 1, or the like), and/or the like. In some cases, the historical and current records of issues may include at least one of historical interactions between the first user and service provider agents of the service provider, previous issues associated with the first service provided to the first user, or previous issues associated with similar services provided to the plurality of users within the geographic area, and/or the like.

Method 300 may continue onto the process at operation 335 in FIG. 3B following the circular marker denoted, "A."

At operation 335 in FIG. 3B (following the circular marker denoted, "A," in FIG. 3A), method 300 may include the computing system calculating user engagement metrics associated with the first user, based on the user interaction data. At operation 340, the computing system may calculate a user engagement index associated with the first user, based on the user engagement metrics. At operation 345, the computing system may predict at least one sentiment and at least one behavioral pattern of the first user, by further analyzing at least one of the one or more queries or the user interaction data. At operation 350, the computing system may categorize user engagement into a categorized engagement level of a plurality of engagement levels, based on the user engagement index, the plurality of engagement levels corresponding to a level of potential difficulty in terms of interactions between the first user and service provider agents. In some cases, the level of potential difficulty may correspond to a level of reasonableness or a level of emotional instability of the user as determined based on the sentiment analysis and/or the behavioral pattern analysis, and/or the like. At operation 355, the computing system may determine whether one or more of the at least one intent, the at least one sentiment, or the at least one behavioral pattern of the first user indicates that a service provider agent reaching out to the first user would facilitate interactions between the service provider and the first user. If so, method 300 either may continue onto the process at operation 360 and/or may continue onto the process at operation 375. In examples, the determination that one or more of the at least one intent, the at least one sentiment, or the at least one behavioral pattern of the first user indicates that the service provider agent reaching out to the first user would facilitate interactions between the service provider and the first user (at operation 355) may be based on the categorized engagement level (from operation 350).

Before or concurrent with the processes at operations 335-355, the computing system may receive agent performance data associated with each of a plurality of service provider agents (e.g., the plurality of agents 150a-150x of FIG. 1, or the like) of the service provider (at operation 360). At operation 365, the computing system may calculate agent capability metrics associated with each of the plurality of service provider agents, based on corresponding agent performance data. In some examples, the agent capability metrics may include at least one of resolution times with users, resolution scores associated with resolving user issues, user satisfaction scores, or interaction scores associated with interactions with users having categorized engagement levels beyond a threshold engagement level, and/or the like. At operation 370, the computing system may calculate agent capability index associated with each of the plurality of service provider agents, based on the agent capability metrics. Method 300 may continue onto the process at operation 375.

At operation 375, the computing system may autonomously match the first user with one or more service provider agents among the plurality of service provider agents, in some cases, based on a combination of the user engagement index, a plurality of agent capability scores associated with the plurality of service provider agents, the predicted at least one intent of the first user, the predicted at least one sentiment of the first user, and the predicted at least one behavioral pattern of the first user. In some cases, the plurality of agent capability scores may include the agent capability index associated with each of the plurality of service provider agents. In examples, autonomously matching the first user with the one or more service provider agents (at operation 375) may be further based on the categorized engagement level (from operation 350).

At operation 380, the computing system may autonomously route a communication line that connects the first user to a first available service provider agent among the one or more service provider agents. At operation 385, the computing system may provide the first available service provider agent with information including information regarding the one or more queries and information regarding the one or more actions that are performed to address the identified at least one of the one or more current issues with the first service provided to the first user or the one or more potential future issues with the first service provided to the first user.

In some examples, the user engagement metrics may include at least one of previous interaction times between the first user and service provider agents of the service provider, an interaction frequency between the first user and the service provider agents, a pattern of interactions between the first user and the service provider agents, or user ratings of interactions between the first user and the service provider agents, and/or the like. In some cases, the user engagement index may be calculated using one or more logistic regression algorithms based on the user engagement metrics.

FIG. 4 depicts a flow diagram illustrating an example method 400 for facilitating user–service provider interactions using an insights engine framework, in accordance with various embodiments. Referring to FIG. 4, the operations of example method 400 may be performed by one or more of an orchestration engine (e.g., orchestration engine 102 of FIG. 1, or the like), an insights engine framework (e.g., insights engine framework 112 of FIG. 1, or the like), and/or components thereof (e.g., computing system 104a or 104b, analytical engine 114, preprocessor 116, metrics analysis system 118, agent analytics system 120, AI compute engine 122, decision matrix 126, outcome engine 130, and/or provisioning system 132 of FIG. 1, or the like) (in some cases, collectively referred to herein as "computing system").

In the example method 400 of FIG. 4, at operation 405, a computing system may receive, from a user device (e.g., one of user devices 136a-136n of FIG. 1, or the like) associated with a first user (e.g., one of users 138a-138n of FIG. 1, or the like), one or more queries regarding a first service provided by a service provider (e.g., service provider 134 of FIG. 1, or the like). In some examples, the first service may be provisioned to a first CPE at a first premises (e.g., CPE 142 among CPE 142a-142y located at premises 144a-144y of FIG. 1, or the like) and/or at one or more network equipment (e.g., one or more network equipment 146 among a plurality of network equipment 146a-146z of FIG. 1, or the like). At operation 410, the computing system may receive user interaction data associated with the first user. In examples, the at least one of the one or more queries or the user interaction data may be analyzed using NLP. In some instances, the one or more of the at least one intent, the at least one sentiment, or the at least one behavioral pattern of the first user may be predicted using one or more AI models (e.g., one or more AI models 124 of FIG. 1, or the like). In some examples, the user interaction data may include at least one of voice interactions with an IVR system (e.g., IVR system 110a of FIG. 1, or the like), voice interactions with human service provider agents (e.g., one or more agents 150a-150x of FIG. 1, or the like), text-based automated chat interactions with an automated chat response system (e.g., chat response system 110b of FIG. 1, or the like), or text-based chat interactions with human service provider agents via a chat response system (e.g., chat response system 110b of FIG. 1, or the like), and/or the like. At operation 415, the computing system may calculate user engagement metrics associated with the first user, based on the user interaction data. In some examples, the user engagement metrics may include at least one of previous interaction times between the first user and service provider agents of the service provider, an interaction frequency between the first user and the service provider agents, a pattern of interactions between the first user and the service provider agents, or user ratings of interactions between the first user and the service provider agents, and/or the like. At operation 420, the computing system may calculate a user engagement index associated with the first user, based on the user engagement metrics. At operation 425, the computing system may predict one or more of at least one intent, at least one sentiment, or at least one behavioral pattern of the first user, in some cases, by analyzing at least one of the one or more queries or the user interaction data. At operation 430, the computing system may categorize user engagement into a categorized engagement level of a plurality of engagement levels, based on the user engagement index (from operation 420). The plurality of engagement levels may correspond to a level of potential difficulty in terms of interactions between the first user and service provider agents. Method 400 may continue onto the process at operation 450.

Before or concurrent with the processes at operations 405-430, the computing system may receive agent performance data associated with each of a plurality of service provider agents (e.g., the plurality of agents 150a-150x of FIG. 1, or the like) of the service provider (at operation 435). At operation 440, the computing system may calculate (or compile) agent capability metrics associated with each of the plurality of service provider agents, based on a corresponding agent performance data. In some examples, the agent capability metrics may include at least one of resolution times with users, resolution scores associated with resolving user issues, user satisfaction scores, or interaction scores associated with interactions with users having categorized engagement levels beyond a threshold engagement level, and/or the like. At operation 445, the computing system may calculate agent capability index associated with each of the plurality of service provider agents, based on the agent capability metrics. Method 400 may continue onto the process at operation 450.

At operation 450, the computing system may autonomously match the first user with one or more service provider agents among a plurality of service provider agents, in some cases, based on a combination of the user engagement index, a plurality of agent capability scores associated with the plurality of service provider agents, and the predicted one or more of the at least one intent, the at least one sentiment, or the at least one behavioral pattern of the first user. In some cases, autonomously matching the first user with the one or more service provider agents (at operation 450) may be further based on the categorized engagement level. At operation 455, the computing system may autonomously route a communication line that connects the first user to a first available service provider agent among the one or more service provider agents.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

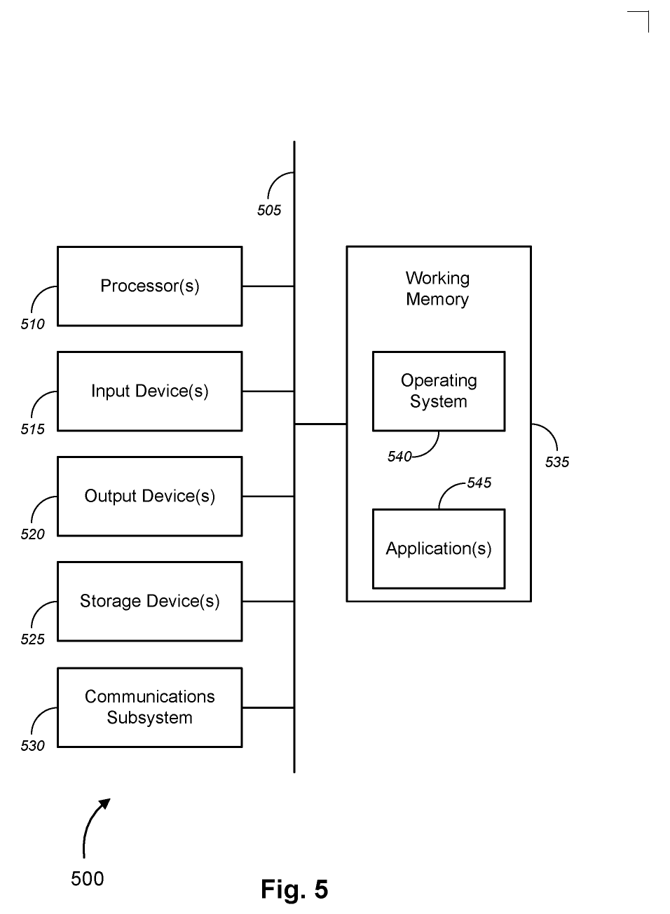

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., orchestration engine 102, computing system 104a or 104b, interface framework 106, monitoring system 108a or 108b, IVR system 110a, chat response system 110b, insights engine framework 112, analytical engine 114, preprocessor 116, metrics analysis system 118, agent analytics system 120, AI compute engine 122, decision matrix 126, outcome engine 130, provisioning system 132, user devices 136a-136n, CPE 142a-142y, network equipment 146a-146z, and agent devices 148a-148x, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500 – which might represent an embodiment of the computer or hardware system (i.e., orchestration engine 102, computing system 104a or 104b, interface framework 106, monitoring system 108a or 108b, IVR system 110a, chat response system 110b, insights engine framework 112, analytical engine 114, preprocessor 116, metrics analysis system 118, agent analytics system 120, AI compute engine 122, decision matrix 126, outcome engine 130, provisioning system 132, user devices 136a-136n, CPE 142a-142y, network equipment 146a-146z, and agent devices 148a-148x, etc.), described above with respect to FIGS. 1-4 – is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network ("WWAN") device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system and from a user device associated with a first user, one or more queries regarding a first service provided by a service provider;
receiving, by the computing system, user interaction data associated with the first user;
predicting, by the computing system, at least one intent of the first user, by analyzing at least one of the one or more queries or the user interaction data;
accessing, by the computing system, historical and current records of issues with a plurality of services provisioned to a plurality of users within a geographic area in which the first service is provided to the first user;
identifying, by the computing system, at least one of one or more current issues with the first service provided to the first user or one or more potential future issues with the first service provided to the first user, based on the predicted at least one intent of the first user, and based on the historical and current records of issues with the plurality of services provisioned to the plurality of users within the geographic area; and
autonomously performing, by the computing system, one or more actions to address the identified at least one of the one or more current issues with the first service provided to the first user or the one or more potential future issues with the first service provided to the first user.

2. The method of claim 1, wherein the user interaction data includes at least one of voice interactions with an interactive voice response ("IVR") system, voice interactions with human service provider agents, text-based automated chat interactions with an automated chat response system, or text-based chat interactions with human service provider agents via a chat response system.

3. The method of claim 1, wherein the historical and current records of issues include at least one of historical interactions between the first user and service provider agents of the service provider, previous issues associated with the first service provided to the first user, or previous issues associated with similar services provided to the plurality of users within the geographic area.

4. The method of claim 1, further comprising:
receiving, by the computing system, agent performance data associated with each of a plurality of service provider agents of the service provider;
calculating, by the computing system, agent capability metrics associated with each of the plurality of service provider agents, based on a corresponding agent performance data; and
calculating, by the computing system, agent capability index associated with each of the plurality of service provider agents, based on the agent capability metrics.

5. The method of claim 4, wherein further comprising:
calculating, by the computing system, user engagement metrics associated with the first user, based on the user interaction data;
calculating, by the computing system, a user engagement index associated with the first user, based on the user engagement metrics;
predicting, by the computing system, at least one sentiment and at least one behavioral pattern of the first user, by further analyzing at least one of the one or more queries or the user interaction data;
based on a determination that one or more of the at least one intent, the at least one sentiment, or the at least one behavioral pattern of the first user indicates that a service provider agent reaching out to the first user would facilitate interactions between the service provider and the first user, performing the following:
autonomously matching, by the computing system, the first user with one or more service provider agents among the plurality of service provider agents, based on a combination of the user engagement index, a plurality of agent capability scores associated with the plurality of service provider agents, the predicted at least one intent of the first user, the predicted at least one sentiment of the first user, and the predicted at least one behavioral pattern of the first user, wherein the plurality of agent capability scores includes the agent capability index associated with each of the plurality of service provider agents;
autonomously routing, by the computing system, a communication line that connects the first user to a first available service provider agent among the one or more service provider agents; and
providing, by the computing system, the first available service provider agent with the one or more queries and with information regarding the one or more actions that are performed to address the identified at least one of the one or more current issues with the first service provided to the first user or the one or more potential future issues with the first service provided to the first user.

6. The method of claim 5, wherein the user engagement metrics include at least one of previous interaction times between the first user and service provider agents of the service provider, an interaction frequency between the first user and the service provider agents, a pattern of interactions between the first user and the service provider agents, or user ratings of interactions between the first user and the service provider agents.

7. The method of claim 5, wherein the user engagement index is calculated using one or more logistic regression algorithms based on the user engagement metrics.

8. The method of claim 5, further comprising:
categorizing, by the computing system, user engagement into a categorized engagement level of a plurality of engagement levels, based on the user engagement index, the plurality of engagement levels corresponding to a level of potential difficulty in terms of interactions between the first user and service provider agents;
wherein the determination that one or more of the at least one intent, the at least one sentiment, or the at least one behavioral pattern of the first user indicates that the service provider agent reaching out to the first user would facilitate interactions between the service provider and the first user is based on the categorized engagement level, and wherein autonomously matching the first user with the one or more service provider agents is further based on the categorized engagement level.

9. The method of claim 5, wherein the agent capability metrics include at least one of resolution times with users, resolution scores associated with resolving user issues, user satisfaction scores, or interaction scores associated with interactions with users having categorized engagement levels beyond a threshold engagement level.

10. The method of claim 5, wherein the at least one of the one or more queries or the user interaction data is analyzed using natural language processing ("NLP"), wherein the one or more of the at least one intent, the at least one sentiment, or the at least one behavioral pattern of the first user is predicted using one or more artificial intelligence ("AI") models.

11. The method of claim 1, wherein the one or more actions include at least one of:
autonomously implementing, by the computing system, one or more updates to equipment providing the first service;
autonomously implementing, by the computing system, one or more upgrades to the equipment providing the first service; or
autonomously ordering, by the computing system, new equipment to replace existing equipment providing the first service, and dispatching, by the computing system, technicians to install the new equipment.

12. A system, comprising:
a computing system; and
memory coupled to the computing system, the memory comprising computer executable instructions that, when executed by the computing system, causes the computing system to perform operations comprising:
receiving, from a user device associated with a first user, one or more queries regarding a first service provided by a service provider;
receiving user interaction data associated with the first user;
predicting at least one intent of the first user, by analyzing at least one of the one or more queries or the user interaction data;
accessing historical and current records of issues with a plurality of services provisioned to a plurality of users within a geographic area in which the first service is provided to the first user;
identifying at least one of one or more current issues with the first service provided to the first user or one or more potential future issues with the first service provided to the first user, based on the predicted at least one intent of the first user, and based on the historical and current records of issues with the plurality of services provisioned to the plurality of users within the geographic area; and
autonomously performing one or more actions to address the identified at least one of the one or more current issues with the first service provided to the first user or the one or more potential future issues with the first service provided to the first user.

13. The system of claim 12, wherein the operations further comprise:
calculating user engagement metrics associated with the first user, based on the user interaction data;
calculating a user engagement index associated with the first user, based on the user engagement metrics;
predicting at least one sentiment and at least one behavioral pattern of the first user, by further analyzing at least one of the one or more queries or the user interaction data;
based on a determination that one or more of the at least one intent, the at least one sentiment, or the at least one behavioral pattern of the first user indicates that a service provider agent reaching out to the first user would facilitate interactions between the service provider and the first user, performing the following:
autonomously matching the first user with one or more service provider agents among a plurality of service provider agents, based on a combination of the user engagement index, a plurality of agent capability scores associated with the plurality of service provider agents, the predicted at least one intent of the first user, the predicted at least one sentiment of the first user, and the predicted at least one behavioral pattern of the first user;
autonomously routing a communication line that connects the first user to a first available service provider agent among the one or more service provider agents; and
providing the first available service provider agent with the one or more queries and with information regarding the one or more actions that are performed to address the identified at least one of the one or more current issues with the first service provided to the first user or the one or more potential future issues with the first service provided to the first user.

14. A method, comprising:
receiving, by a computing system and from a user device associated with a first user, one or more queries regarding a first service provided by a service provider;
receiving, by the computing system, user interaction data associated with the first user;
calculating, by the computing system, user engagement metrics associated with the first user, based on the user interaction data;
calculating, by the computing system, a user engagement index associated with the first user, based on the user engagement metrics;
predicting, by the computing system, one or more of at least one intent, at least one sentiment, or at least one behavioral pattern of the first user, by analyzing at least one of the one or more queries or the user interaction data;
autonomously matching, by the computing system, the first user with one or more service provider agents among a plurality of service provider agents, based on a combination of the user engagement index, a plurality of agent capability scores associated with the plurality of service provider agents, and the predicted one or more of the at least one intent, the at least one sentiment, or the at least one behavioral pattern of the first user; and
autonomously routing, by the computing system, a communication line that connects the first user to a first available service provider agent among the one or more service provider agents.

15. The method of claim 14, wherein the user interaction data includes at least one of voice interactions with an interactive voice response ("IVR") system, voice interactions with human service provider agents, text-based automated chat interactions with an automated chat response system, or text-based chat interactions with human service provider agents via a chat response system.

16. The method of claim 14, wherein the user engagement metrics include at least one of previous interaction times between the first user and service provider agents of the service provider, an interaction frequency between the first user and the service provider agents, a pattern of interactions between the first user and the service provider agents, or user ratings of interactions between the first user and the service provider agents.

17. The method of claim 14, further comprising:
receiving, by the computing system, agent performance data associated with each of the plurality of service provider agents of the service provider;
calculating, by the computing system, agent capability metrics associated with each of the plurality of service provider agents, based on a corresponding agent performance data; and
calculating, by the computing system, agent capability index associated with each of the plurality of service provider agents, based on the agent capability metrics, wherein the plurality of agent capability scores includes the agent capability index associated with each of the plurality of service provider agents.

18. The method of claim 17, further comprising:
categorizing, by the computing system, user engagement into a categorized engagement level of a plurality of engagement levels, based on the user engagement index, the plurality of engagement levels corresponding to a level of potential difficulty in terms of interactions between the first user and service provider agents;
wherein autonomously matching the first user with the one or more service provider agents is further based on the categorized engagement level.

19. The method of claim 18, wherein the agent capability metrics include at least one of resolution times with users, resolution scores associated with resolving user issues, user satisfaction scores, or interaction scores associated with interactions with users having categorized engagement levels beyond a threshold engagement level.

20. The method of claim 14, wherein the at least one of the one or more queries or the user interaction data is analyzed using natural language processing ("NLP"), wherein the one or more of the at least one intent, the at least one sentiment, or the at least one behavioral pattern of the first user is predicted using one or more artificial intelligence ("AI") models.
